(19) United States
(12) Patent Application Publication
(10) Pub. No.: US 2006/0174911 A1
(43) Pub. Date: Aug. 10, 2006

(54) Electric dental floss

(76) Inventor: Haruhiko Naruse, Hikone (JP)

Correspondence Address: GREENBLUM & BERNSTEIN, P.L.C., 1950 ROLAND CLARKE PLACE, RESTON, VA, 20191, US

(21) Appl. No.: 10/565,596

(22) PCT Filed: Jun. 24, 2004
(86) PCT No.: PCT/JP04/09258

§ 371 Date: Apr. 24, 2006

(30) Foreign Application Priority Data
Jul. 25, 2003 (JP) 2003-280359

(51) Int. Cl. A61C 15/00

(52) U.S. Cl. 132/322

(57) ABSTRACT

An electric dental flosser apparatus includes a drive mechanism for rotationally oscillating a drive shaft 4 about its own axis and a floss holder 3 mounted on the drive shaft 4 so as to be oscillated rotationally by the drive shaft 4. A flosser element 5 is stretched taut on the floss holder in a direction perpendicular to an axial direction of the drive shaft 4 so as to pass across an extension line A of the drive shaft 4 or a position adjacent thereto.

### TECHNICAL FIELD

The present invention relates to a dental flosser apparatus employed as an oral sanitary implement and, more particularly, to an electric dental flosser apparatus for electrically rotationally oscillating a strand of floss.

### BACKGROUND ART

A dental floss for cleaning the spaces between the user's teeth is conventionally known as an oral sanitary implement. In cleaning the spaces between the teeth, it is effective to finely move a strand of floss made of a bundle of fine fibers, and an electric dental flosser apparatus for electrically driving the strand of floss has been recently provided.

The electric dental flosser apparatus of this kind is shown in, for example, FIGS. 16 and 17. This electric dental flosser apparatus 1′ includes a drive mechanism for rotationally oscillating a drive shaft (not shown) about its own axis, and also includes a floss holder 3′ mounted on the drive shaft for rotational oscillation together therewith. As shown in FIG. 16, the floss holder 3′ includes a neck portion 8′ attached to the drive shaft and a forked floss holding portion 6′ formed with the neck portion 8′ at a distal end thereof. A proximal end of the floss holding portion 6′ is positioned on an extension line A of the drive shaft. A strand of floss 5′ is stretched taut between opposite distal ends of the floss holding portion 6′, thereby tensioning the strand of floss 5′ in a direction perpendicular to the axial direction of the drive shaft. The strand of floss 5′ passes through a position away from the extension line A of the drive shaft (see, for example, Patent Document 1).

Patent Document 1: Japanese Laid-Open Patent Publication No. 07-425

However, because the proximal end of the floss holding portion 6′ is positioned on the extension line A of the drive shaft and because the strand of floss 5′ passes through a position away from the extension line A of the drive shaft, the distance between the extension line A of the drive shaft and the opposite distal ends of the floss holding portion 6′ is large. Accordingly, when the electric dental flosser apparatus 1′ is driven, the width C of oscillation of the opposite distal ends of the floss holding portion 6′, i.e., the two portions of the floss holder 3′ that hold opposite ends of the strand of floss 5′ becomes very large, as shown in FIG. 17. As a result, under the condition in which the dental flosser apparatus 1′ is in operation, when the strand of floss 5′ is inserted between the teeth or during flossing in which the strand of floss 5′ has been inserted between the teeth, if the opposite distal ends of the floss holding portion 6′ impinge on the teeth, an internal wall of the mouth or the like, not only the user feels unpleasant, but also effective flossing cannot be carried out in some cases.

The present invention has been developed to overcome the above-described disadvantages.

It is accordingly an objective of the present invention to provide an electric dental flosser apparatus capable of improving the feeling of use and performing effective flossing by rendering, when the strand of floss is inserted between the teeth or during flossing in which the strand of floss has been inserted between the teeth under the condition in which the dental flosser apparatus is in operation, the portions of the floss holder that hold opposite ends of the strand of floss not to easily impinge on the teeth, an internal wall of the mouth or the like.

Another objective of the present invention is to provide an electric dental flosser apparatus capable of effective flossing by oscillating the strand of floss in a direction of a line that connects an intermediate portion of the strand of floss stretched between opposite distal end portions of a forked floss holding portion with a proximal end portion of the floss holding portion.

### DISCLOSURE OF THE INVENTION

In accomplishing the above objectives, the electric dental flosser apparatus according to the present invention includes a drive shaft, a drive mechanism operable to rotationally oscillate the drive shaft about its own axis, a floss holder mounted on the drive shaft so as to be oscillated rotationally by the drive shaft, and a flosser element stretched on the floss holder. The flosser element is held taut in a direction perpendicular to an axial direction of the drive shaft so as to pass across an extension line of the drive shaft or a position adjacent thereto.

This construction can reduce the distance between the extension line of the drive shaft and those portions of the floss holder that hold opposite ends of the flosser element and, hence, when the electric dental flosser apparatus is in operation, the width of oscillation of such portion of the floss holder holding the opposite ends of the flosser element can be reduced. As a result, under the condition in which the electric dental flosser apparatus is in operation, when the flosser element is inserted between the teeth or during flossing in which the flosser element has been inserted between the teeth, the portions of the floss holder holding the opposite ends of the flosser element won't easily impinge on the teeth, an internal wall of the mouth or the like, making it possible to improve the feeling of use without any unpleasant feeling given to the user and to accomplish safe and effective flossing.

The floss holder may include a forked floss holding portion. In this case, an intermediate portion of a line connecting an intermediate portion of the flosser element and a proximal end portion of the floss holding portion is positioned on an extension line of the drive shaft or a neighborhood thereof.

This construction can also reduce the distance between the extension line of the drive shaft and opposite distal end portions of the floss holding portion and, hence, when the electric dental flosser apparatus is in operation, the width of oscillation of the opposite distal end portions of the floss holding portion can be reduced. As a result, under the condition in which the electric dental flosser apparatus is in operation, when the flosser element is inserted between the teeth or during flossing in which the flosser element has been inserted between the teeth, the opposite distal end portions of the floss holding portion won't easily impinge on the teeth, an internal wall of the mouth or the like, making it possible to improve the feeling of use without any unpleasant feeling given to the user and to accomplish safe and effective flossing. Also, because the center of rotational oscillation of the flosser element is positioned on an intermediate portion of a line that connects an intermediate portion of the flosser element with the proximal end portion of the floss holding portion, it becomes possible to move the flosser element back and forth in a direction of such a line, resulting in more effective flossing.

Further, the floss holder may include an elastically deformable neck portion mounted on the drive shaft and a floss holding portion mounted on the neck portion.

If the neck portion is elastically deformable, when the flosser element is inserted between the teeth, a load applied to the flosser element elastically deforms the neck portion, and an intermediate portion of the flosser element moves towards the extension line of the drive shaft or a neighborhood thereof, making it possible to easily insert the flosser element between the teeth. Also, during flossing in which the flosser element is placed between the teeth, the load that has been applied to the flosser element is reduced or lost and, hence, the neck portion returns to its original state before the elastic deformation in which the intermediate portion of the line connecting the intermediate portion of the flosser element and the proximal end portion of the floss holding portion is positioned on the extension line of the drive shaft or the neighborhood thereof. As a result, the flosser element oscillates in the direction of such line, making it possible to accomplish effective flossing.

Conveniently, the neck portion mounted on the drive shaft and the floss holding portion mounted on the neck portion are formed independently, and the floss holding portion having the flosser element stretched thereon is removably mounted on the neck portion.

By this construction, replacement of the flosser element that is regarded difficult for the ordinary users can be easily carried out merely by replacing the floss holding portion on which the flosser element is stretched taut. Also, the flosser element can be held under uniform tension and, at the same time, the floss holding portion can be disposed of after use, making it possible to provide hygienic flossing.

If the floss holding portion is made of a biodegradable plastic material, the floss holding portion can be buried in the ground after use, and even if it is burnt, it won't damage a furnace because it produces a lower quantity of heat than the ordinary plastic materials do with no toxic substances such as dioxin produced. Further, even if the user swallows, though this is not unlikely during normal use, the floss holding portion by mistake, he or she won't be adversely affected thereby.

The floss holder may include a generally U-shaped floss holding portion having a floss guide groove defined in opposite distal end surfaces and a portion or the entirety of an outer side surface thereof. In this case, a length of floss can be wound around the floss holding portion while received in the floss guide groove.

With this construction, replacement of the flosser element that is regarded difficult for the ordinary users can be easily carried out by stretching the flosser element taut between the opposite distal end portions of the U-shaped floss holding portion. Further, commercially available floss that has been cut into a predetermined length can be used as a length of floss, resulting in an economical use of the electric dental flosser apparatus.

If the floss holder is removably mounted on the drive shaft, any one of a plurality of floss holders having different shapes can be selectively mounted on the drive shaft to accomplish effective flossing, or different floss holders can be selectively used depending on the users. Also, in the case where the floss holder wears out, it is sufficient if only the floss holder is replaced, resulting in an economical use of the electric dental flosser apparatus.

The floss holding portion may be inclined such that the flosser element stretched thereon is positioned on a further distal end side beyond the distal end of the neck portion in an axial direction of the drive shaft.

In this case, the flosser element can be easily inserted into the mouth without causing the floss holding portion and the neck portion to impinge on the teeth, an internal wall of the mouth or the like. Also, even during flossing in which the flosser element has been inserted between the teeth, it is unlikely that the floss holding portion or the neck portion would impinge on teeth adjacent to the target teeth, an internal wall of the mouth or the like.

If a plurality of flosser elements are stretched taut on the floss holder, effective flossing can be accomplished.

### BRIEF DESCRIPTION OF THE DRAWINGS

FIG. 1A is a front elevational view of an electric dental flosser apparatus according to a first embodiment of the present invention.

FIG. 1B is a side view, partly in section, of the electric dental flosser apparatus of FIG. 1A.

FIG. 2 is a perspective view of a floss holder mounted on the electric dental flosser apparatus of FIG. 1A.

FIG. 3 is a top plan view of the electric dental flosser apparatus of FIG. 1A.

FIG. 4 is a top plan view of the electric dental flosser apparatus of FIG. 1A when a flosser element attached thereto is inserted between the teeth.

FIG. 5 is a top plan view of an electric dental flosser apparatus according to a second embodiment of the present invention.

FIG. 6A is a front elevational view of the electric dental flosser apparatus of FIG. 5.

FIG. 6B is a side view of the electric dental flosser apparatus of FIG. 5.

FIG. 7A is a top plan view of the electric dental flosser apparatus of FIG. 5 when a flosser element is inserted between the teeth.

FIG. 7B is a top plan view of the electric dental flosser apparatus of FIG. 5 during flossing.

FIG. 8 is an exploded perspective view of a neck portion and a floss holder both mounted on an electric dental flosser apparatus according to a third embodiment of the present invention.

FIG. 9A is a perspective view of a floss holder mounted on an electric dental flosser apparatus according to a fourth embodiment of the present invention, particularly depicting a condition prior to winding a strand of floss around the floss holder.

FIG. 9B is another perspective view of the floss holder of FIG. 9A, particularly depicting a condition after the strand of floss has been wound around the floss holder.

FIG. 10A is a perspective view of a floss holder for the back teeth mounted on an electric dental flosser apparatus according to a fifth embodiment of the present invention.

FIG. 10B is a side view of the floss holder of FIG. 10A.

FIG. 11A is a perspective view of a floss holder for the front teeth mounted on the electric dental flosser apparatus according to the fifth embodiment of the present invention.

FIG. 11B is a side view of the floss holder of FIG. 11A.

FIG. 12 is a perspective view of an end portion of a body of the electric dental flosser apparatus according to the fifth embodiment of the present invention.

FIG. 13 is a side view of a floss holder mounted on an electric dental flosser apparatus according to a sixth embodiment of the present invention.

FIG. 14 is a side view of the electric dental flosser apparatus according to the sixth embodiment of the present invention when a flosser element is inserted between the teeth.

FIG. 15 is a top plan view of an electric dental flosser apparatus according to a seventh embodiment of the present invention.

FIG. 16 is a perspective view of a conventional electric dental flosser apparatus.

FIG. 17 is a top plan view of the electric dental flosser apparatus of FIG. 16.

### BEST MODE FOR CARRYING OUT THE INVENTION

Preferred embodiments of the present invention are described hereinafter with reference to the drawings.

### Embodiment 1

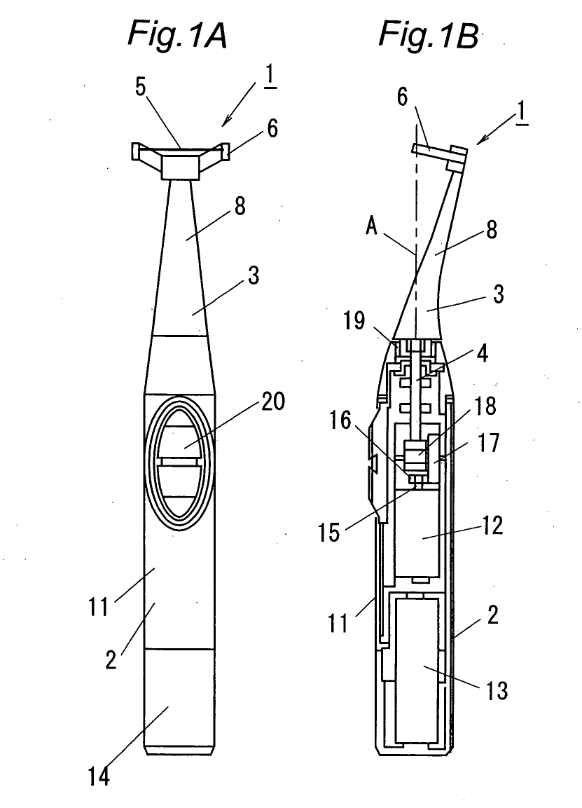

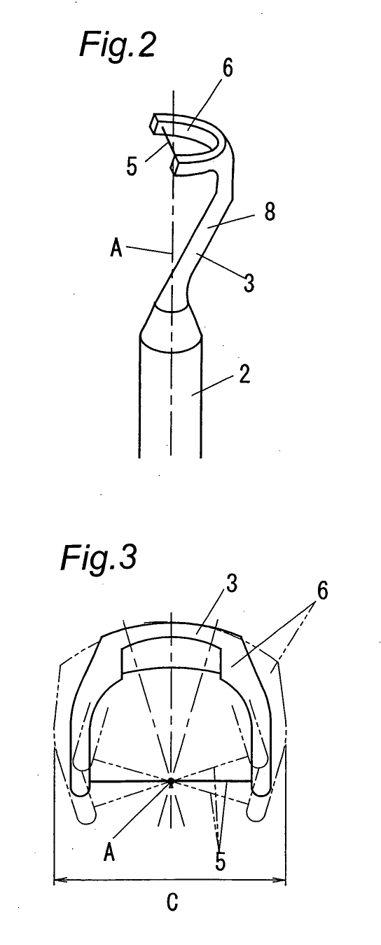

An electric dental flosser apparatus 1 shown in FIGS. 1A, 1B, 2, and 3 includes a dental flosser body 2 having a generally cylindrical hollow casing 11, and also includes a drive shaft 4 protruding from an end portion of the dental flosser body 2 and a floss holder 3 mounded on the drive shaft 4.

The dental flosser body 2 accommodates a motor 12 and a dry cell 13 employed as a power source for the motor 12 or a power unit for the electric dental flosser apparatus 1. The dry cell 13 can be replaced upon removal of a dry cell cover 1-4 that forms a portion of the body casing 11. The drive shaft 4 is supported within the end portion of the dental flosser body 2 so that a longitudinal axis of the drive shaft 4 is held in alignment with a longitudinal axis of the dental flosser body 2. The drive shaft 4 is connected to a motor shaft 15 of the motor 12 via a motion conversion mechanism accommodated within the dental flosser body 2.

The motion conversion mechanism acts to convert a rotational motion about the motor shaft 15 to a rotational oscillating motion about the drive shaft 4 (that is, an oscillating motion in a direction about the drive shaft). In the illustrated electric dental flosser apparatus 1, the motion conversion mechanism includes a face gear 17 held in mesh with a gear 16 secured to the motor shaft 15 and an eccentric cam 18 for converting rotation of the face gear 17 to the rotational oscillating motion of the drive shaft 4.

Reference numeral 19 shown in FIG. 1B denotes a waterproof packing for ensuring waterproof of the interior of the dental flosser body 2.

The floss holder 3 is mounted at its proximal end portion on an end portion of the drive shaft 4, and includes a neck portion 8 mounted on the drive shaft 4 and a floss holding portion 6 unitarily formed with the neck portion 8 to hold a flosser element 5.

The neck portion 8 has a proximal end portion mounted on the end portion of the drive shaft 4 that protrudes from an end portion of the dental flosser body 2. The neck portion 8 is curved from the proximal end portion thereof towards a distal end portion thereof so as to be gradually apart from an extension line A of the drive shaft 4. That is, the neck portion 8 is smoothly inclined with respect to the extension line A of the drive shaft 4.

The floss holding portion 6 has a forked shape or is generally formed into a figure “U” as viewed from the drive shaft 4, and a proximal end portion of the floss holding portion 6 is formed with the distal end portion of the neck portion 8. A strand of floss or flosser element 5 is stretched taut between opposite distal end portions of the floss holding portion 6 so as to extend in a direction perpendicular to the axial direction of the drive shaft 4 and pass across the extension line A of the drive shaft 4. In the illustrated embodiment, an intermediate portion of the flosser element 5 crosses the extension line A of the drive shaft 4, but it may pass across a position adjacent to the extension line A of the drive shaft 4.

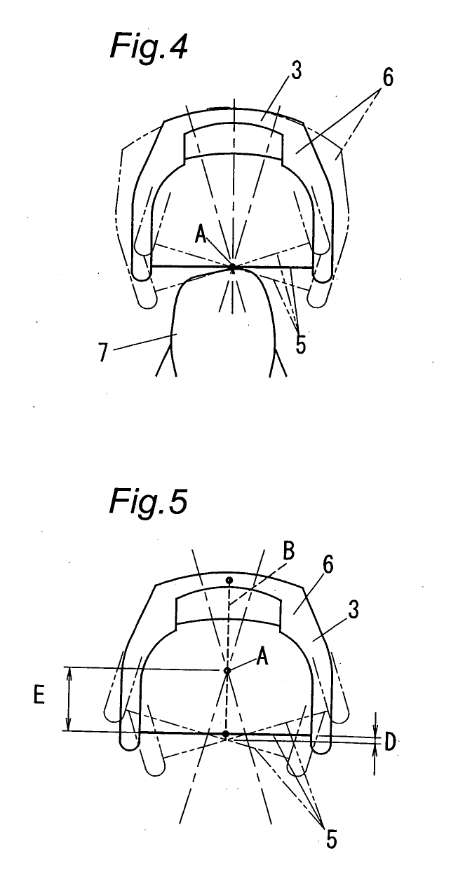

The body casing 11 has an ON/OFF switch 20 mounted on a front portion thereof to turn on or off the motor 12. When the motor 12 is driven, rotation of the motor shaft 15 causes a rotational oscillation of the drive shaft 4 about its longitudinal axis and, at the same time, a rotational oscillation of the floss holder 3, which in turn causes a rotational oscillation of both the floss holding portion 6 and the flosser element 5 about the extension line A of the drive shaft 4 (or the neighborhood of the extension line A of the drive shaft 4), as shown in FIG. 3. In this case, it is preferred that the rotation angle of the drive shaft 4 be set in the range of 5-30 degrees and that the rotational oscillating speed be set in the range of 1000-4000 rpm with one reciprocating motion as one cycle. Upon insertion of such a rotationally oscillating flosser element 5 into the mouth and then between the teeth as shown in FIG. 4, interdental cleaning by the flosser element 5, i.e., flossing can be accomplished.

Because the flosser element 5 is stretched taut in a direction perpendicular to the axial direction of the drive shaft 4 so as to pass across the extension line A of the drive shaft 4 or the neighborhood thereof, the distance between the extension line A of the drive shaft 4 and the opposite distal end portions of the floss holding portion 6 becomes small and, hence, when the electric dental flosser apparatus 1 is in operation, the width C of oscillation of the opposite distal end portions of the floss holding portion can be reduced as shown in FIG. 3, compared with the conventional electric dental flosser apparatus 1′. As a result, under the condition in which the electric dental flosser apparatus 1 is in operation, when the flosser element 5 is inserted between the teeth or during flossing in which the flosser element 5 has been inserted between the teeth, the opposite distal end portions of the floss holding portion 6 won't easily impinge on the teeth, an internal wall of the mouth or the like, making it possible to improve the feeling of use without any unpleasant feeling given to the user and to accomplish safe and effective flossing. Because the flosser element 5 is positioned so as to pass across the extension line A of the drive shaft 4 or the neighborhood thereof, the electric dental flosser apparatus 1 according to the present invention also has the advantage of being able to easily insert an intermediate portion of the flosser element 5 between the teeth.

### Embodiment 2

In this embodiment, as shown in FIG. 5, an intermediate portion of a line B that connects an intermediate portion of the flosser element 5 stretched between the opposite distal end portions of the floss holding portion 6, which has been formed into a forked shape or a figure “U” as viewed from the drive shaft 4, with the proximal end portion of the floss holding portion 6 is positioned on the extension line A of the drive shaft 4 or the neighborhood thereof. Preferably, the distance E between the flosser element 5 and the extension line A of the drive shaft 4 is in the range of about 3-8 millimeters.

When the motor 12 is driven, both the floss holder 3 and the flosser element 5 having opposite ends held by the floss holder 3 are rotationally oscillated about the intermediate portion of the line B (the extension line A of the drive shaft 4 or the neighborhood thereof), as shown in FIG. 5. At the same time, the flosser element 5 moves back and forth within a width of stroke D in the direction of the line B, as shown in FIG. 5.

As described hereinabove, by positioning the intermediate portion of the line B on the extension line A of the drive shaft 4 or the neighborhood thereof, when the electric dental flosser apparatus 1 is in operation, the distance between the extension line A of the drive shaft 4 and the opposite distal end portions of the floss holding portion 6 can be reduced, as in the first embodiment, making it possible to reduce the width C of oscillation of the opposite distal end portions of the floss holding portion 6 during operation of the electric dental flosser apparatus 1. In addition, the back and forth motion of the flosser element 5 in the direction of the line B results in more effective flossing.

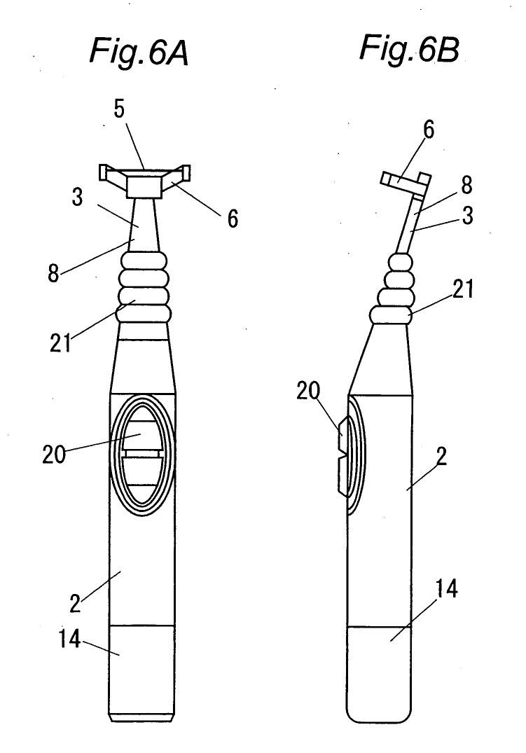

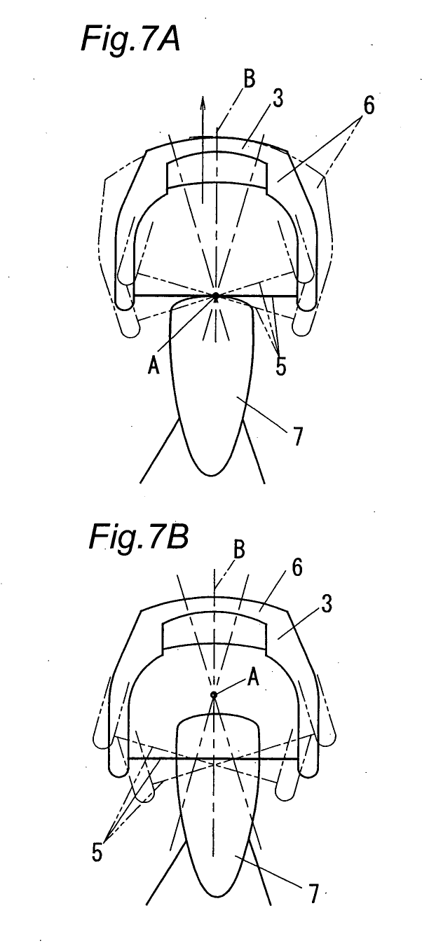

It is preferred that the neck portion 8 be elastically deformable, as best shown in FIGS. 6A and 6B. In the illustrated example, the neck portion 8 has an elastic portion 21 formed at an intermediate portion thereof that is made of an elastic body. Elastomer is preferably used for the elastic body. In this case, it is preferred that when a load of 150-200 grams is applied to the flosser element 5 in a direction of an arrow in FIG. 7A, the elastic portion 21 bends so as to move the flosser element 5 about 5 millimeters.

It is to be noted here that the manner in which the neck portion 8 is formed elastically deformable is not limited to the neck portion 8 having the elastic portion 21, but the neck portion 8 may have a thickness or shape that elastically deforms the neck portion 8.

In this case, when the flosser element 5 is inserted in between the teeth, the load applied to the flosser element 5 elastically deforms the neck portion 8, as shown in FIG. 7A, and the intermediate portion of the flosser element 5 moves towards the extension line A of the drive shaft 4, thus facilitating insertion of the intermediate portion of the flosser element 5 in between the teeth. During flossing in which the intermediate portion of the flosser element 5 is placed between the teeth, the load that has been applied to the flosser element 5 is reduced or lost, as shown in FIG. 7B. Accordingly, the neck portion 8 returns to its original state before the elastic deformation in which the intermediate portion of the line B is positioned on the extension line A of the drive shaft 4 or the neighborhood thereof, and the flosser element 5 oscillates in the direction of the line B, making it possible to accomplish effective flossing.

### Embodiment 3

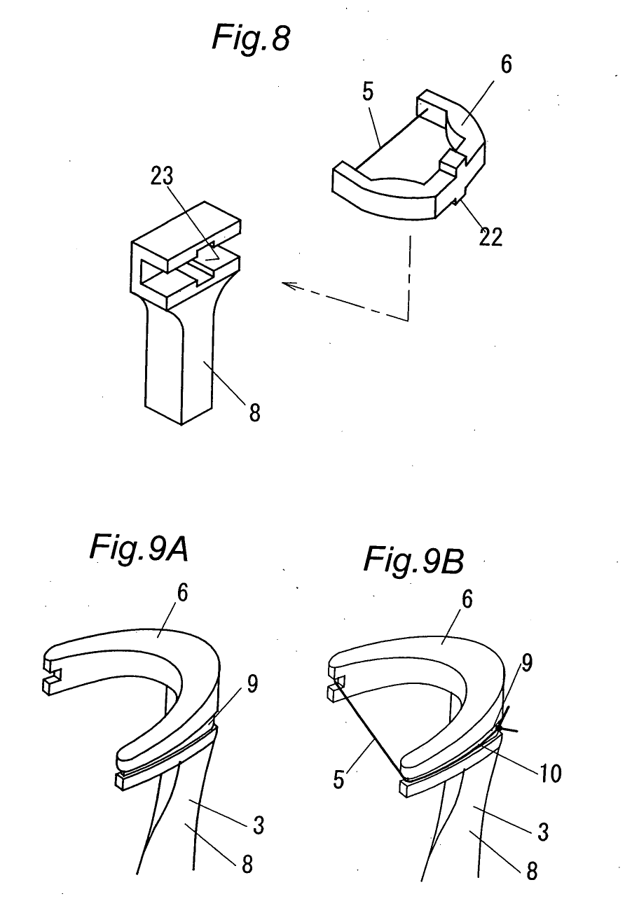

In this embodiment, as shown in FIG. 8, the neck portion 8 and the floss holding portion 6 are formed independently, and the floss holding portion 6 having the flosser element 5 stretched thereon is removably mounted on the neck portion 8. More specifically, the floss holding portion 6 has two protrusions 22 formed therewith on generally flat upper and lower surfaces of a proximal end (intermediate portion) thereof, while the neck portion 8 has a generally U-shaped distal end portion, a groove 23 formed in the distal end portion and having opposite inner walls extending parallel to each other, and two recesses each formed in one of the opposite inner walls of the groove 23 to receive one of the two protrusions 22 of the floss holding portion 6 therein, so that the intermediate portion of the floss holding portion 6 can be removably mounted on the distal end portion of the neck portion 8. If one of the proximal end portion of the floss holding portion 6 and the groove 23 in the neck portion 8 is provided with a protrusion made of an elastic member, while the other of the proximal end portion of the floss holding portion 6 and the groove 23 in the neck portion 8 is provided with a recess to receive such a protrusion therein, the floss holding portion 6 clicks when it is being mounted on the neck portion 8.

With this configuration in which the neck portion 8 and the floss holding portion 6 are formed independently, and the floss holding portion 6 having the flosser element 5 stretched thereon is removably mounted on the neck portion 8, replacement of the flosser element 5 that is regarded difficult for the ordinary users can be easily carried out merely by replacing the floss holding portion 6 on which the flosser element 5 is stretched taut. In this case, the flosser element 5 is held under uniform tension and, at the same time, the floss holding portion 6 can be disposed of after use, making it possible to provide hygienic flossing.

It is preferred that the floss holding portion 6 be made of a biodegradable plastic material such as a poly-lactic acid-based one or a starch-based one. The biodegradable plastic material can be used in the same manner as the ordinary plastic products and is a plastic material that is resolved, after use, into water and carbon dioxide by microorganisms and/or resolving enzymes existing in the natural world to return to nature. The floss holding portion 6 made of such a biodegradable plastic material can be buried in the ground after use, and even if it is burnt, it won't damage a furnace because it produces a lower quantity of heat than the ordinary plastic materials do with no toxic substances such as dioxin produced. Further, even if the user swallows, though this is not unlikely during normal use, the floss holding portion 6 made of a biodegradable plastic material by mistake, he or she won't be adversely affected thereby.

It is to be noted here that the construction according to this embodiment is applicable to the second embodiment referred to above.

### Embodiment 4

In this embodiment, as shown in FIGS. 9A and 9B, the floss holding portion 6 is generally U-shaped and has a floss guide groove 9 defined in opposite distal end surfaces thereof and an entire outer side surface thereof. A length of floss 10 is wound around the floss holding portion 6 while received in the floss guide groove 9, so that the flosser element 5 may be stretched taut between the opposite distal end portions of the U-shaped floss holding portion 6. Opposite ends of the length of floss 10 are tied on the proximal end portion side of the floss holding portion 6.

Although not shown, the floss guide groove 9 may be formed in the opposite distal end surfaces and a portion of the outer side surface of the U-shaped floss holding portion 6.

With this construction, replacement of the flosser element 5 that is regarded difficult for the ordinary users can be easily carried out by stretching the flosser element 5 taut between the opposite distal end portions of the U-shaped floss holding portion 6 in the above-described manner. Further, commercially available floss that has been cut into a predetermined length can be used as a length of floss 10, making it possible to reduce the manufacturing cost and running cost.

It is to be noted here that the construction according to this embodiment is applicable to the second or third embodiment referred to above.

### Embodiment 5

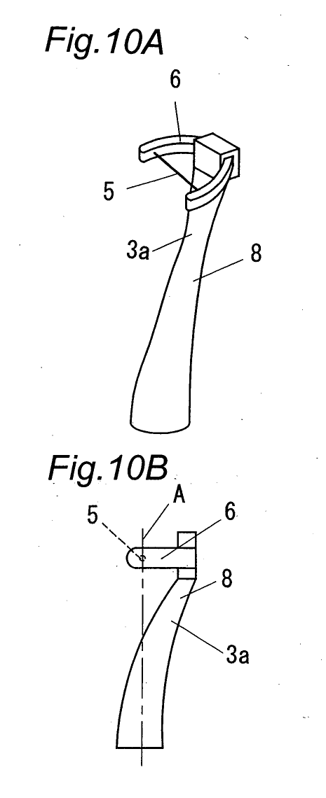

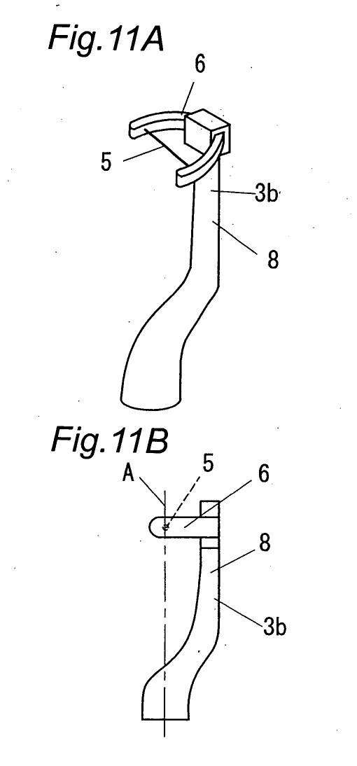

In this embodiment, the floss holding portion 6 having the flosser element 5 stretched thereon is removably mounted on the drive shaft 4. This construction is applicable to a floss holder 3a for the back teeth, as shown in FIGS. 10A and 10B, in which the neck portion 8 is smoothly inclined from a proximal end portion thereof towards a distal end portion thereof so as to be gradually apart from the extension line A of the drive shaft 4, and also to a floss holder 3b for the front teeth, as shown in FIGS. 11A and 11B, in which the proximal end portion of the neck portion 8 is curved so that the distal end portion of the neck portion 8 may be positioned apart from the extension line A of the drive shaft 4. The floss holder 3a for the back teeth or the floss holder 3b for the front teeth can be selectively mounted on the drive shaft 4 to accomplish effective flossing. Alternatively, different floss holders 3 can be selectively used depending on the users. Also, even if only the floss holder 3 is missing, the electric dental flosser apparatus 1 can still be used with a new floss holder 3, resulting in an economical use.

Further, because the construction according to the third embodiment referred to above in which the floss holding portion 6 is removably mounted on the neck portion 8 is used up in some cases due to, for example, wear of the floss holding portion 6, it is particularly effective to apply the construction according to this embodiment to the third embodiment.

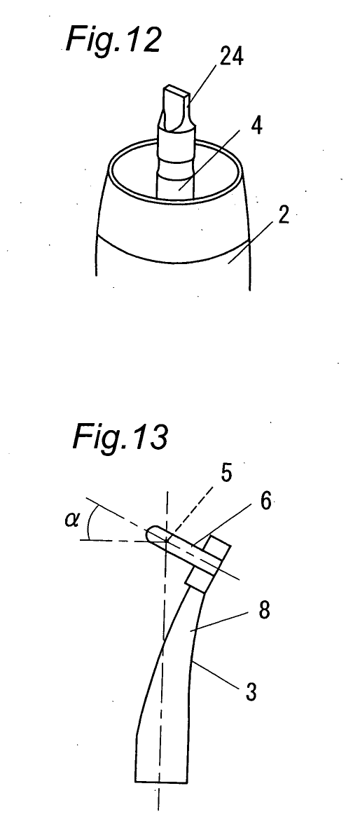

It is to be noted here that connection between the floss holder 3 and the drive shaft 4 can be accomplished by engaging a protrusion formed on one of a proximal end portion of the floss holder 3 and a distal end portion of the drive shaft 4 with a recess formed in the other of the proximal end portion of the floss holder 3 and the distal end portion of the drive shaft 4. In an example illustrated in FIG. 12, the drive shaft 4 has a protrusion 24 formed on the distal end portion thereof, while the floss holder 3 has a recess (not shown) defined in the proximal end portion thereof.

In this embodiment also, the floss holder 3 may be made of a biodegradable plastic material, and this embodiment is also applicable to any one of the second to fourth embodiments.

### Embodiment 6

In this embodiment, as shown in FIG. 13, the floss holding portion 6 is inclined such that the flosser element 5 stretched on the floss holding portion 6 is positioned on a further distal end side beyond the distal end of the neck portion 8 in the axial direction of the drive shaft 4. In this case, an angle a formed between the floss holding portion 6 and a plane perpendicular to the drive shaft 4 is preferably set in the range of 10-30 degrees.

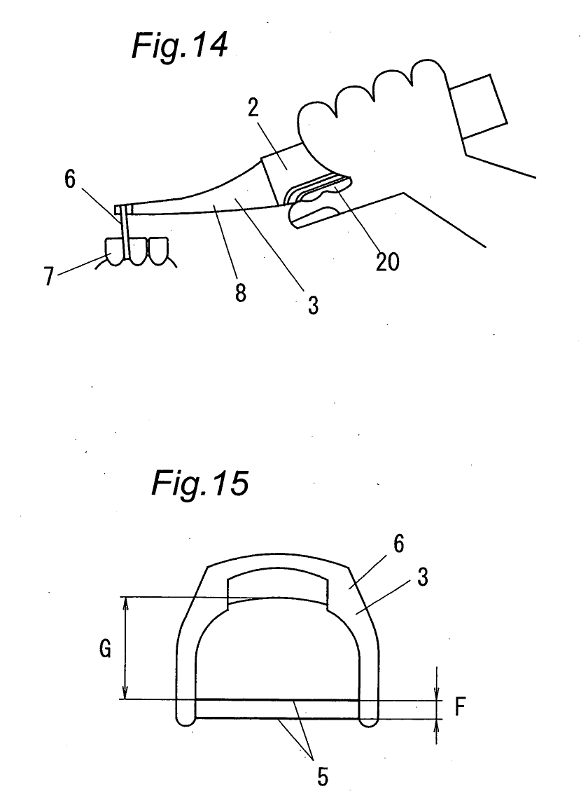

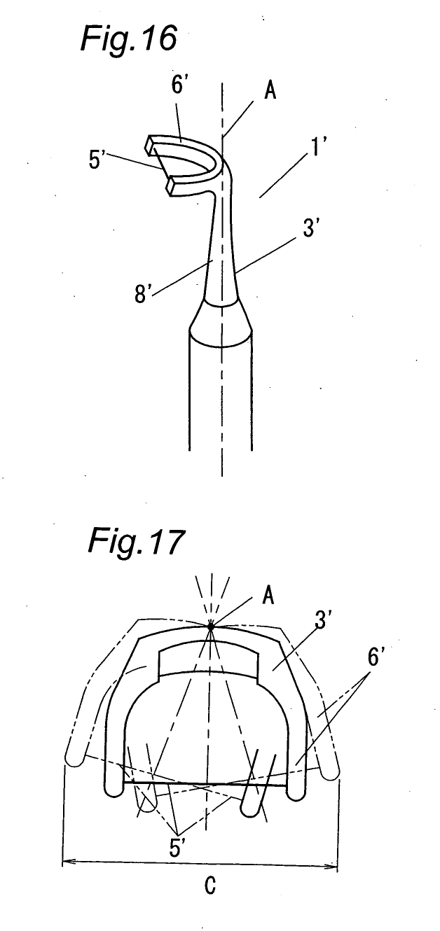

This configuration allows the floss holding portion 6 and the neck portion 8 to be easily inserted into the mouth without causing the floss holding portion 6, the neck portion 8, and the dental flosser body 2 to impinge on the teeth 7, an internal wall of the mouth or the like. Also, as shown in FIG. 14, even during flossing in which the flosser element 5 has been inserted between the teeth, it is unlikely that the floss holding portion 6, the neck portion 8, and the dental flosser body 2 would impinge on teeth adjacent to the target teeth, an internal wall of the mouth or the like.

This embodiment is applicable to any one of the second to fifth embodiments referred to above.

### Embodiment 7

In this embodiment, as shown in FIG. 15, a plurality of flosser elements 5 are stretched on the floss holder 3. In the illustrated example, two flosser elements 5 are held taut between the opposite distal end portions of the floss holding portion 6 so as to extend parallel to each other in a direction perpendicular to the drive shaft 4. It is preferred that the distance F between the two flosser elements 5 be about two millimeters. It is also preferred that the distance G between the inwardly positioned flosser element 5 and an internal side wall of the intermediate portion of the floss holding portion 6 be in the range of 10-15 millimeters, considering insertion of the plurality of flosser elements 5 in between the teeth.

The provision of the plurality of flosser elements 5 stretched on the floss holder 3 enables effective flossing.

This embodiment is applicable to any one of the second to sixth embodiments referred to above.

1. An electric dental flosser apparatus comprising:
a drive shaft;
a drive mechanism operable to rotationally oscillate the drive shaft about its own axis;
a floss holder mounted on the drive shaft so as to be oscillated rotationally by the drive shaft; and
a flosser element stretched on the floss holder;
wherein the flosser element is held taut in a direction perpendicular to an axial direction of the drive shaft so as to pass across an extension line of the drive shaft or a position adjacent thereto.

2. An electric dental flosser apparatus comprising:
a drive shaft;
a drive mechanism operable to rotationally oscillate the drive shaft about its own axis;
a floss holder mounted on the drive shaft so as to be oscillated rotationally by the drive shaft, the floss holder comprising a forked floss holding portion having a proximal end portion and opposite distal end portions; and
a flosser element stretched taut between the opposite distal end portions of the floss holding portion;
wherein an intermediate portion of a line connecting an intermediate portion of the flosser element and the proximal end portion of the floss holding portion is positioned on an extension line of the drive shaft or a neighborhood thereof.

3. (canceled)

4. The electric dental flosser apparatus according to claim 1, wherein the floss holder comprises a neck portion mounted on the drive shaft and a floss holding portion mounted on the neck portion, and wherein the neck portion and the floss holding portion are formed independently, and the floss holding portion having the flosser element stretched thereon is removably mounted on the neck portion.

5. The electric dental flosser apparatus according to claim 4, wherein the floss holding portion is made of a biodegradable plastic material.

6. The electric dental flosser apparatus according to claim 1, wherein the floss holder comprises a generally U-shaped floss holding portion having opposite distal end surfaces, an outer side surface, and a floss guide groove defined in the opposite distal end surfaces and at least a portion of the outer side surface, and wherein a length of floss is wound around the floss holding portion while received in the floss guide groove.

7. The electric dental flosser apparatus according to claim 1, wherein the floss holder having the flosser element stretched thereon is removably mounted on the drive shaft.

8. The electric dental flosser apparatus according to claim 1, wherein the floss holder comprises a neck portion mounted on the drive shaft and a floss holding portion mounted on the neck portion, and wherein 'the floss holding portion is inclined such that the flosser element stretched on the floss holding portion is positioned on a further distal end side beyond a distal end of the neck portion in an axial direction of the drive shaft.

9. The electric dental flosser apparatus according to claim 1, wherein a plurality of flosser elements are stretched taut on the floss holder.

10. The electric dental flosser apparatus according to claim 2, wherein the floss holder comprises an elastically deformable neck portion mounted on the drive shaft and a floss holding portion mounted on the neck portion.

11. The electric dental flosser apparatus according to claim 2, wherein the floss holder comprises a neck portion mounted on the drive shaft and a floss holding portion mounted on the neck portion, and wherein the neck portion and the floss holding portion are formed independently, and the floss holding portion having the flosser element stretched thereon is removably mounted on the neck portion.

12. The electric dental flosser apparatus according to claim 11, wherein the floss holding portion is made of a biodegradable plastic material.

13. The electric dental flosser apparatus according to claim 2, wherein the floss holder comprises a generally U-shaped floss holding portion having opposite distal end surfaces, an outer side surface, and a floss guide groove defined in the opposite distal end surfaces and at least a portion of the outer side surface, and wherein a length of floss is wound around the floss holding portion while received in the floss guide groove.

14. The electric dental flosser apparatus according to claim 2, wherein the floss holder having the flosser element stretched thereon is removably mounted on the drive shaft.

15. The electric dental flosser apparatus according to claim 2, wherein the floss holder comprises a neck portion mounted on the drive shaft and a floss holding portion mounted on the neck portion, and wherein the floss holding portion is inclined such that the flosser element stretched on the floss holding portion is positioned on a further distal end side beyond a distal end of the neck portion in an axial direction of the drive shaft.

16. The electric dental flosser apparatus according to claim 2, wherein a plurality of flosser elements are stretched taut on the floss holder.
